(19) United States
(12) Patent Application Publication
(10) Pub. No.: US 2025/0251415 A1
(43) Pub. Date: Aug. 7, 2025

(54) CAROUSEL FOR USE WITH LABORATORY AUTOMATION SYSTEM

(71) Applicants: Laurin Oberhauser, Schaanwald (LI); Adrian Wegiel, Schaanwald (LI)

(72) Inventors: Laurin Oberhauser, Schaanwald (LI); Adrian Wegiel, Schaanwald (LI)

(21) Appl. No.: 18/430,320

(22) Filed: Feb. 1, 2024

(51) Int. Cl. G01N 35/02; G01N 35/00

(52) U.S. Cl. CPC G01N 35/025; G01N 35/0092; G01N 35/0099; G01N 2035/00891

(57) ABSTRACT

According to an aspect of the present invention, there is provided a carousel for storage of microplates to be processed in a laboratory automation system, comprising: a plurality of hotels for storing microplates in assigned locations; a motor configured to cause rotation of the carousel to position a hotel storing a microplate to be processed in proximity to a robotic device for handling the microplate to be processed; and a controller for the motor.

### BACKGROUND

Microplate storage and handling devices and systems are known in the prior art patent literature. In such systems, microplates are removed from a storage location to be processed by a machine and it is generally desirable to process a large number of microplates. Automation systems are usually designed with a robotic arm to move microplates between a microplate storage devices and a testing device. By storing a large number of microplates in a storage device, a robotic arm can load and remove many microplates from the machine for testing and processing by laboratory equipment. A random access storage device allows every plate stored in the device to be accessed without removing any other plates, while a sequential storage device is designed to allow plates to be handled in sequence.

Prior art patents for microplate storage devices include U.S. Pat. No. 6,663,334, which discloses an apparatus for random access storage and retrieval of a plurality of microplates. The apparatus includes a plurality of microplate racks arranged in a stack. Each of the racks is mechanically engaged with a plurality of support columns and each of the columns has a plurality of locking devices corresponding to the plurality of racks. The apparatus also includes a lift, coupled to the support columns, for moving the stack or a portion thereof, and a controller, coupled to the lift and the locking devices. The controller is responsive to a signal to access a desired rack or microplate to cause actuation of one or more of the locking devices corresponding to the rack adjacent to the desired rack or microplate, followed by actuation of the lift, thereby moving a portion of the stack a sufficient distance to allow access to the desired rack or microplate.

However, prior art microplate storage devices suffer from limitations, including capacity, reliability, ease of use, and lack of ability for manual intervention.

### SUMMARY OF INVENTION

Therefore, the present invention provides an improved carousel comprising multiple hotels storing microplates for use with an automated laboratory system.

According to an aspect of the present invention, there is provided a carousel for storage of microplates to be processed in a laboratory automation system, comprising: a plurality of hotels for storing microplates in assigned locations; a motor configured to cause rotation of the carousel to position a hotel storing a microplate to be processed in proximity to a robotic device for handling the microplate to be processed; and a controller for the motor.

According to another aspect of the present invention, there are provided tracks for locking the hotels to the base of the carousel. One or more spring-loaded ball catches are provided on the tracks. There can be provided additionally one or more ball catches on the base of the carousel.

### BRIEF DESCRIPTION OF THE DRAWINGS

FIG. 1 illustrates a perspective view of a carousel for storing microplates according to the present invention.

FIG. 2 illustrates a side view of a carousel for storing microplates according to the present invention.

FIG. 3 illustrates the motor and gears of the carousel.

FIG. 4 illustrates a spring-loaded ball catch.

### DETAILED DESCRIPTION

Embodiments of the present invention are designed to operate in conjunction with, for instance, the PreciseFlex 400 sample handler robot manufactured by Brooks Automation or the KX-2 Collaborative Laboratory Robot manufactured by PAA. Many other microplate handling robots can be used as well.

Microplates typically have 6, 12, 24, 48, 96, 384 or 1536 sample wells arranged in a rectangular matrix with landscape and portrait orientation. However, other arrangements of holders of biologic materials may be used such as those with more wells for arrays, such as 3456 or 9600 wells. Embodiments of the present invention might be adapted to contain such holders as tubes, vials, petri dishes, and the like.

Typically, a controller for the robot will integrate with the carousel for storing microplates according to the present invention to provide unified and coordinated control. Embodiments of the present invention can be controlled via the same software that controls e.g., the KX-2 Collaborative Robot or the PreciseFlex 400 sample handler robot.

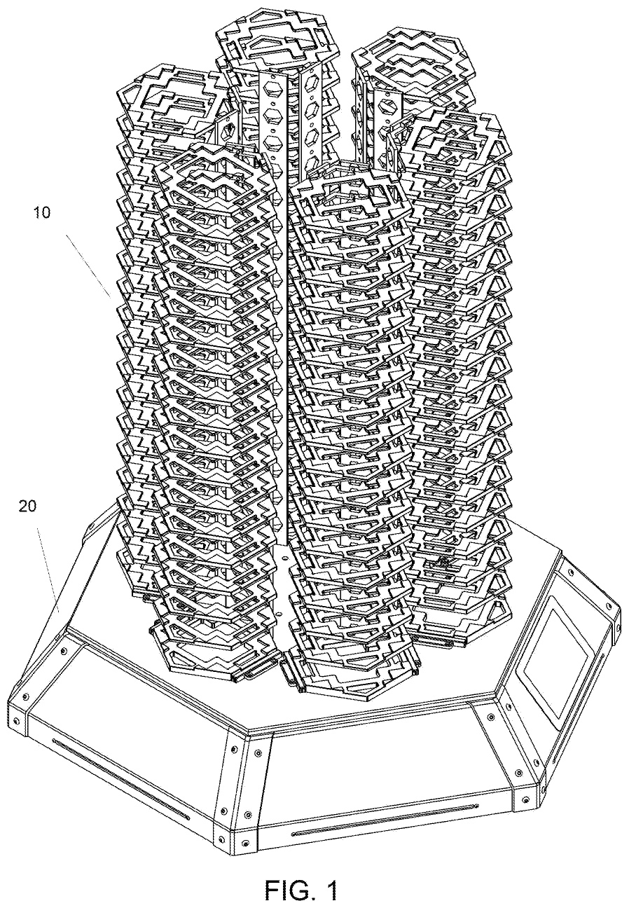

FIG. 1 illustrates a perspective view of a carousel for storing microplates according to the present invention.

Carousel base 20 is shown in FIG. 1 with hotels 10 situated on the carousel base.

Carousel base 20 has a motor and a controller. The motor is configured to rotate the carousel. The controller is configured to control the motor. The controller can be connected to a communications port and be controlled by a signal through the communications port, e.g., from the software that controls e.g., the KX-2 Collaborative Robot or the PreciseFlex 400 sample handler robot. The communications ports can be RS232, RJ45, or USB ports, for example.

Carousel base 20 has a display screen, e.g., an LCD screen. The display screen indicates the current locations of each of the hotels on the carousel. The display screen can be a touch screen configured to receive a command to move the hotels to a desired position from the manual entry of a user, which can substitute for the scheduling software jointly controlling the robot and the carousel.

Carousel base 20 can be provided with LED status indicators. For example, the LED status indicators can indicate that the carousel is ready, is in operation or is experiencing an error.

Hotels 10 sit on carousel base 20 and contain microplates. The hotels can attach to the carousel base by tracks for locking the hotels to the base of the carousel. One or more spring-loaded ball catches are provided on the tracks.

The cassette base for hotels 10 inserting into the tracks can have a U-shaped latch or an L-shaped latch which is complimentary to the shape of the track.

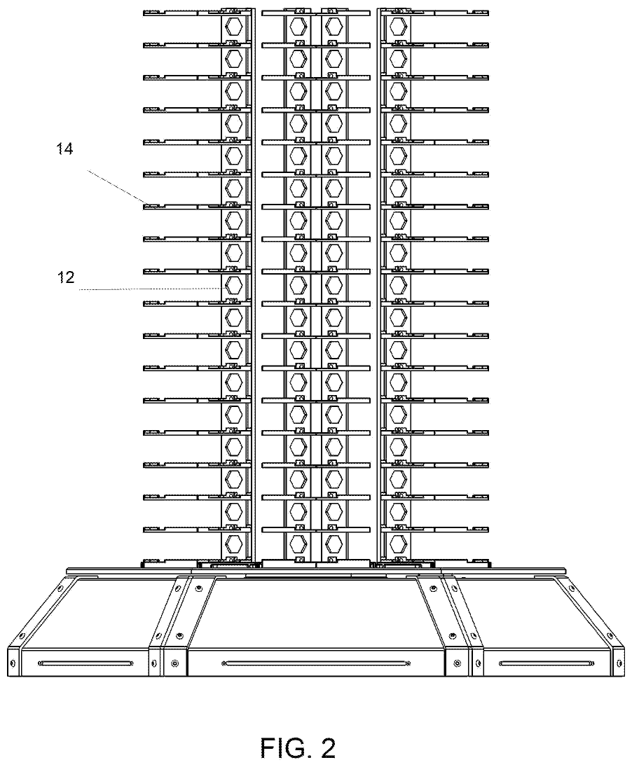

FIG. 2 illustrates a side view of a carousel for storing microplates according to the present invention.

Support column 12 is attached to a number of shelves 14. Each shelf 14 contains a microplate which can be accessed by e.g., the KX-2 Collaborative Robot or the PreciseFlex 400 sample handler robot.

The hotels can have shelves spaced to allow clearance for microplates without the shelves having to be lifted. The microplates can be 15.11 mm in height, or greater spacing in some embodiments for clearance for deep well plates with about 44 mm in height.

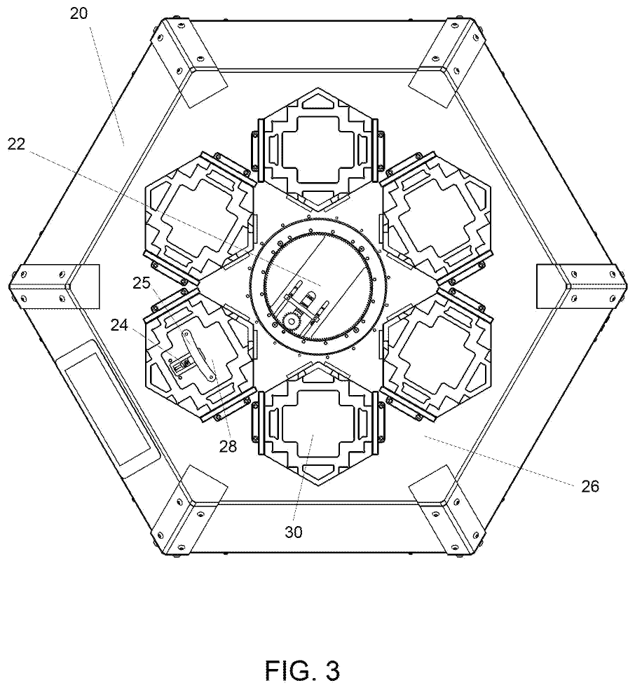

FIG. 3 illustrates the motor and gears of the carousel.

Carousel base plate 26 of carousel 20 rotates by a motor with gears 22. A gear is attached to the motor shaft which drives a slewing ring. The slewing ring is a toothed bearing, which is connected to the carousel base plate. The carousel rotates by gears with a direct drive from the motor. The carousel base has a geared bearing which is attached directly to a gear attached to the shaft of the drive motor.

Sensor 24 is provided to detect carousel locator 25. Carousel locator 25 is associated with a first cassette base 28 and the motor turns until the sensor 24 reaches the carousel locator 25. If the sensor and carousel locator are not perfectly aligned, an offset is provided. Second cassette base 30 does not have a locator attached.

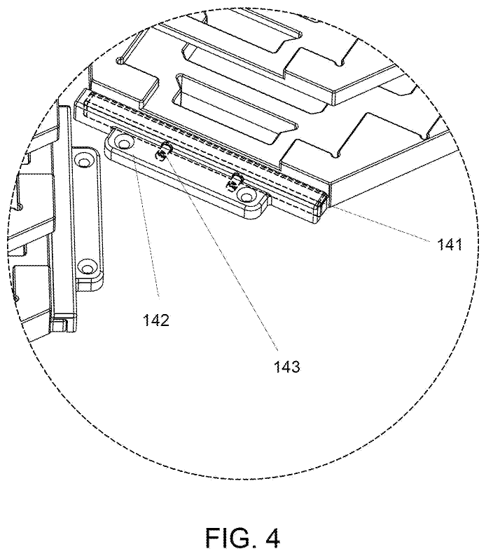

FIG. 4 illustrates a spring-loaded ball catch.

Ball catches on the cassette base 141 are configured to catch one or more spring-loaded ball latches 143 on the tracks 142. There can be provided additionally one or more spring-loaded ball latches on the base of the carousel, and ball catches can be provided on the underside of the cassette base. The arrangement of spring-loaded ball latches and ball catches can also be reversed.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A carousel for storage of microplates to be processed in a laboratory automation system, comprising:
a plurality of hotels for storing microplates having cassette bases;
a motor configured to cause rotation of the carousel to position a hotel storing a microplate to be processed in proximity to a robotic device for handling the microplate to be processed; and
a controller for the motor.

2. The carousel for storage of microplates to be processed in a laboratory automation system of claim 1, further comprising tracks for locking the hotels to the base of the carousel.

3. The carousel for storage of microplates to be processed in a laboratory automation system of claim 2, further comprising one or more ball catches on the cassette bases configured to catch one or more spring-loaded ball latches on the tracks.

4. The carousel for storage of microplates to be processed in a laboratory automation system of claim 1, further comprising one or more ball catches on the base of the carousel to configured to catch one or more catch spring-loaded ball latches on the cassette bases.

5. The carousel for storage of microplates to be processed in a laboratory automation system of claim 1, further comprising LED status indicators.

6. The carousel for storage of microplates to be processed in a laboratory automation system of claim 1, further comprising a display screen.

7. The carousel for storage of microplates to be processed in a laboratory automation system of claim 6, wherein the display screen indicates the current locations of each of the hotels on the carousel.

8. The carousel for storage of microplates to be processed in a laboratory automation system of claim 1, further comprising a positioning sensor for identifying where the carousel is to start.

9. The carousel for storage of microplates to be processed in a laboratory automation system of claim 1, wherein the hotels are configured to hold microplates in either portrait or landscape orientation.

10. The carousel for storage of microplates to be processed in a laboratory automation system of claim 2, wherein the cassette inserting into the tracks has an L-shaped latch.

11. The carousel for storage of microplates to be processed in a laboratory automation system of claim 2, wherein the cassette inserting into the tracks has an U-shaped latch.

12. The carousel for storage of microplates to be processed in a laboratory automation system of claim 6, wherein the display screen is a touch screen configured to receive a command to move the hotels to a desired position.

13. The carousel for storage of microplates to be processed in a laboratory automation system of claim 1, further comprising a communications port.

14. The carousel for storage of microplates to be processed in a laboratory automation system of claim 13, wherein the controller is configured to receive input from a scheduler through the communications port.

15. The carousel for storage of microplates to be processed in a laboratory automation system of claim 1, wherein the carousel is hexagonal.

16. The carousel for storage of microplates to be processed in a laboratory automation system of claim 15, wherein there are six hotels.

17. The carousel for storage of microplates to be processed in a laboratory automation system of claim 1, wherein microplates have a footprint of 127.76 mm×85.48 mm±0.5 mm.

18. The carousel for storage of microplates to be processed in a laboratory automation system of claim 1, wherein the microplates have 6, 12, 24, 48, 96, 384 or 1536 sample wells.

19. The carousel for storage of microplates to be processed in a laboratory automation system of claim 1, wherein the microplates have a height of 14.35 mm±0.76 mm.

20. The carousel for storage of microplates to be processed in a laboratory automation system of claim 19, wherein the hotels have racks spaced to allow clearance for microplates of 15.11 mm in height.
